(19) United States
(12) Patent Application Publication
(10) Pub. No.: US 2017/0291154 A1
(43) Pub. Date: Oct. 12, 2017

(54) METHOD AND APPARATUS FOR REDUCTION OF AIR INGESTION DURING MIXING

(71) Applicant: TURBULENT TECHNOLOGIES LTD., Haifa (IL)

(72) Inventors: Yuri KOKOTOV, MaAle Adumim (IL); Roman SHEINMAN, Kfar- Saba (IL); Leonid BRAGINSKY, MaAle Adumim (IL)

(21) Appl. No.: 15/127,024

(22) PCT Filed: Mar. 26, 2015
(86) PCT No.: PCT/IL2015/050318

§ 371 Date: Sep. 18, 2016

Related U.S. Application Data
(60) Provisional application No. 61/971,097, filed on Mar. 27, 2014.

(51) Int. Cl. B01F 7/22; B01F 7/16; B01F 7/06; B01F 15/00

(52) U.S. Cl. CPC B01F 7/22; B01F 15/00915; B01F 7/1675; B01F 7/1665; B01F 7/063; B01F 7/021

(57) ABSTRACT

A mixing tank is disclosed for reducing ingestion across an interface. The tank may include a first zone including most of the volume of the tank; a second zone including the interface; a source of mixing energy configured to provide a first bulk energy dissipation rate in the first zone; a divider located between said first zone and said second zone inhibiting transfer of said mixing energy from said first zone to said second zone to preserve in said second zone a bulk power dissipation level less than a said first bulk power dissipation level; and a mass transport passageway between said first zone and said second zone for preserving a uniformity between the first and second zones. A method is disclosed for manufacturing a mixing tank and for retrofitting and existing mixing tank and for managing mixing to prevent air ingestion.

### RELATED APPLICATION/S

This application claims the benefit of priority under 35 USC §119(e) of U.S. Provisional Patent Application No. 61/971,097 filed 27 Mar. 2014, the contents of which are incorporated herein by reference in their entirety.

### FIELD AND BACKGROUND OF THE INVENTION

The present invention, in some embodiments thereof, relates to reduction of ingestion across in interface in a tank and/or reactor and, more particularly, but not exclusively, to a reducing air ingestion in mixing tanks.

U.S. Pat. No. 6,827,908 relates to a standpipe for circulating catalyst from one vessel to another, the standpipe having an inlet design which reduces gas entrainment during catalyst transport by partial de-fluidization in the standpipe inlet region. The standpipe inlet design could include multiple inlet openings through the top of the standpipe or from the side wall by slots, or both, and a horizontal disk surrounding the standpipe below the slots for blocking the upward flow of bubbles, the combination thereby forming a dense fluidization zone above the disk and surrounding the inlet, including the slots. Additionally, the disk may include a downwardly-projecting lip or edge forming an inverted void space around the standpipe and the downwardly-projecting edge may further include vent holes around its circumference which allow bubbles trapped under the disk to be vented outside the standpipe inlet region. Above and below the disk and surrounding the standpipe, gas injection rings may be used to prevent the dense fluidization zone above the disk from complete de-fluidization, thus assisting the catalyst to remain fluidized and flow smoothly into the standpipe either through the slots or at the very top of the open standpipe, or both.

U.S. Pat. No. 6,585,405 discloses a fluid mixer that mixes liquids while simultaneously promoting rapid mixing entrainment of vapor in the liquid. The device includes a vertical rotor mounted centrally on a base assembly. The rotor comprises a tube which is hollow from an open top end to a bottom closed end, having an external screw thread in a right-side configuration relative from top to bottom and one or more holes located in the sidewall of the tube at the bottom of the hollow portion of the tube, preferably located centrally between two flanking surfaces of the screw thread. The base assembly comprises a stirbar and a supporting disk which contains a ceramic magnet. The base rests on the floor of a containment vessel. A magnetic stirring motor is centrally located sufficiently close to and beneath the containment vessel as to achieve magnetic flux coupling with the base magnet. Operation of the mixer develops a liquid vortex in the liquid phase material. As the speed increases, the external screw threads generate turbulence and draw vapor into the liquid from above the tube and urge the vapor into intimate contact with the turbulent, droplet-forming liquid. A circulation develops causing a vortex to develop. As the speed of circulation increases, the surface of the liquid is lowered until it matches the hole in the sidewall of the tube. The liquid enters the holes in the sidewall of the tube along with entrained vapor, and rises through the liquid in the hollow tube, and exits the open top end.

Additional background art includes Barabash V. M., Braginsky L. N. and Gorbacheva G. B. (1987). On analysis of gas holdup in agitated vessels. Theor. Found. of Chem. Eng., 21(5) pp. 654-660. Braginsky L. and Kokotov Y. (1997) Kinetics of Break-Up and Coalescence of Drops in Mixing Vessels. International Symposium on Liquid-Liquid Two Phase Flow and Transport Phenomena, Antalya, Turkey, 1997, pp. 567-5′74. Braginsky L. N., Begachev V. I., Barabash V. M. (1984) Mixing of liquids. Theoretical basements and methods of technical calculation. Himia Publishers, Leningrad. Harnby N., Edwards M. F. and Nienow A. W. (1997) Mixing in the Process Industries. Butterworth-Heinemann, Oxford. Ritcey, G. M. (1980) Crud in solvent extraction processing: review of causes and treatment. Hydrometallurgy, 5:97-107.

### SUMMARY OF THE INVENTION

According to an aspect of some embodiments of the present invention there is provided a method of reducing ingestion across an interface of a mixing tank including: mixing a first zone including at least 75% of the mixing tank to achieve a first bulk energy dissipation level in the first zone; preserving in a second zone near the interface a second bulk energy dissipation level, the second energy dissipation level being less than half of the first bulk energy dissipation level; and transporting material between the first zone and the second zone.

According to some embodiments of the invention, the preserving includes obstructing a path of flow directed from the first zone toward the second zone.

According to some embodiments of the invention, the obstructing includes placing the divider in an upflow region of the unobstructed flow.

According to some embodiments of the invention, the preserving includes increasing a depth of the second zone when the second bulk energy dissipation level surpasses a minimum air entry level.

According to some embodiments of the invention, the increasing a depth of the second zone includes increasing a water level in the tank.

According to some embodiments of the invention, the preserving includes decreasing the transporting when the second bulk energy dissipation level surpasses a minimum air entry level.

According to some embodiments of the invention, the decreasing transporting includes decreasing a net inter-zone flow rate from the first zone to the second zone through the passageway.

According to some embodiments of the invention, the decreasing transport includes changing a rate of external circulation.

According to some embodiments of the invention, the decreasing transport includes changing a balance of inflow rate and outflow rate between the first zone and the second zone.

According to some embodiments of the invention, the method further includes: interrupting a central vortex.

According to some embodiments of the invention, the interrupting includes preventing a central vortex from crossing between the first zone and the second zone.

According to some embodiments of the invention, the interrupting includes placing a central baffle in a location of an uninterrupted central vortex.

According to some embodiments of the invention, the method further includes: detecting a high level of the ingestion and adjusting an inter-zone flow rate to reduce the ingestion.

According to an aspect of some embodiments of the present invention there is provided a mixing tank for reducing ingestion across an interface including: a first zone including at least 75% of the total volume of the tank; a second zone including the interface; a source of mixing energy configured to provide a first level of bulk energy dissipation in the first zone; a divider located between the first zone and the second zone interfering with transfer of the mixing energy from the first zone to the second zone to preserve in the second zone a bulk energy dissipation level less than half the first bulk energy dissipation level; and a mass transport passageway between the first zone and the second zone.

According to some embodiments of the invention, the divider obstructs a flow path from the first zone to the second zone in the unobstructed mean flow.

According to some embodiments of the invention, the mass transport passageway includes an opening in the divider.

According to some embodiments of the invention, the tank further includes: a second baffle interrupting a central vortex.

According to some embodiments of the invention, the second baffle prevents the central vortex from penetrating from the second zone to the first zone.

According to some embodiments of the invention, the second baffle is placed in a location of the central vortex in the uninterrupted flow.

According to some embodiments of the invention, the transport passageway has a cross sectional area of smaller than eleven times the depth of the second zone multiplied by the square root of the area of the interface divided by the sum of one and the square of the ratio of the average rotation velocity in the first zone to the average pulsation velocity in the bulk of the first zone.

According to some embodiments of the invention, the divider can be moved to change a volume of the first zone.

According to some embodiments of the invention, the divider includes a peripheral baffle obstructing flow between the first zone and the second zone along a wall of the tank and wherein the divider includes the passageway in a central portion thereof.

According to some embodiments of the invention, a width of the peripheral baffle is at least a third the hydraulic radius of the mixing tank.

According to some embodiments of the invention, the peripheral baffle is in the form of an annulus.

According to some embodiments of the invention, the tank further includes: a sensor for a level of the ingestion and a controller for adjusting an inter-zone flow rate in response to the sensing.

According to some embodiments of the invention, an outlet can be adjusted to change a volume of the second zone.

According to an aspect of some embodiments of the present invention there is provided a method for producing a mixing tank with reduced ingestion across an interface including: dividing a first zone including at least 75% of the total volume of the tank from a second zone including the interface; installing a source of mixing energy source in the first zone providing turbulent flow; interfering with energy transfer from the first zone to the second zone; and providing a passageway for material transport between the first zone and the second zone.

According to some embodiments of the invention, the interfering includes obstructing a flowpath in uninterfered mean flow from the first zone towards the interface.

According to some embodiments of the invention, the flowpath is an upflow path.

According to some embodiments of the invention, the passageway is configured to preserve a bulk energy dissipation in the second zone that is less than ½ a bulk energy dissipation in the first zone.

According to some embodiments of the invention, the energy source is an impeller.

According to some embodiments of the invention, the method further includes: providing a baffle for inhibiting tangential flow in the first zone.

According to some embodiments of the invention, the method further includes: providing a baffle for inhibiting tangential flow in the second zone.

According to some embodiments of the invention, the method further includes: configuring the tank for changing a volume of the first zone.

According to some embodiments of the invention, the configuring includes configuring the divider to move.

According to some embodiments of the invention, the method further includes: configuring the tank for changing a volume of the second zone.

According to some embodiments of the invention, the configuring includes configuring the fluid outlet to move.

According to an aspect of some embodiments of the present invention there is provided a method of retrofitting a mixing tank to reduce ingestion across an interface including: dividing a first zone including at least 75% of the total volume of the tank from a second zone including the interface; interfering with energy transfer from the first zone to the second zone; and providing a passageway for material transport between the first zone and the second zone.

According to some embodiments of the invention, the interfering includes obstructing a flowpath in uninterfered mean flow from the first zone towards the interface.

According to some embodiments of the invention, the flowpath is an upflow path.

According to some embodiments of the invention, the passageway is configured to preserve a bulk energy dissipation level in the second zone that is less than ½ a bulk energy dissipation in the first zone.

According to some embodiments of the invention, the method further includes: providing a baffle for inhibiting tangential flow in the first zone.

According to some embodiments of the invention, the method further includes: providing a baffle for inhibiting tangential flow in the second zone.

According to some embodiments of the invention, the method further includes: configuring the tank for changing a volume of the first zone.

According to some embodiments of the invention, the configuring includes configuring the divider to move.

According to some embodiments of the invention, the method further includes: configuring the tank for changing a volume of the second zone.

According to some embodiments of the invention, the configuring includes configuring the fluid outlet to move.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings and images in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a flowchart illustration of a method of reducing ingestion across an interface in accordance with some embodiments of the present invention;

FIG. 1B is a flowchart illustration of a method of operation of a mixing tank reducing ingestion across an interface in accordance with some embodiments of the present invention;

FIG. 2 is a schematic illustration of a vertical mixing tank in accordance with some embodiments of the present invention;

FIG. 3 is a graph illustrating calculated dependence of the dissipation energy ratio between two zones on the cross sectional area of a passageway between the zones according to some embodiments of the current invention;

FIG. 4 is a block diagram illustrating a tank in accordance with some embodiments of the current invention;

FIG. 5 is a schematic illustration of an alternative geometry for a vertically mixed tank in accordance with some embodiments of the present invention;

FIGS. 6A-6C are schematic illustrations of top down views of a tank in accordance with some embodiments of the present invention;

FIG. 7 is a schematic cross sectional illustration of tank in accordance with some embodiments of the present invention;

FIGS. 8A and 8B are schematic illustrations of two alternative tanks with non-vertical impeller shafts in accordance with some embodiments of the present invention;

FIGS. 8C and 8D are schematic illustrations of a pipe flow tank and divider in accordance with an embodiment of the current invention.

FIGS. 9A-9E are schematic illustrations and images of an example of an experimental system according to some embodiments of the present invention;

FIGS. 10A and 10B are photo images respectively of a tank lacking a divider and a tank including a divider in accordance with some embodiments of the present invention;

FIG. 11A is a graph illustrating the ratio of impeller speed at the minimum aeration limit MAL for a tank without a divider and a tank with a divider according to some embodiments of the present invention; and

FIG. 11B is a graph illustrating correlation between a calculated ratio of energy between the quiescent and actively stirred zones and measured ratios of impeller speed at the minimum aeration limit MAL for a tank without a divider and a tank with a divider according to some embodiments of the present invention.

### DESCRIPTION OF SPECIFIC EMBODIMENTS OF THE INVENTION

Overview

The present invention, in some embodiments thereof, relates to reduction of ingestion across an interface in a tank and/or reactor and, more particularly, but not exclusively, to a reducing air ingestion in mixing tanks.

1) Method Reduce Air Ingestion

An aspect of the present invention in some embodiments thereof relates to a method for reducing ingestion across an interface in a mixed tank and/or a method for production of a mixed tank having reduced ingestion across an interface. Optionally, the tank may be divided into to two zones. For the sake of the present disclosure, ingestion may include entrainment and/or diffusion of material across an interface. For the sake of the current disclosure the term tank and/or mixing tank may include various kinds of tanks and/or reactors for example a mixer, a coalescer, a disperser, dissolver and/or a mixing tank (for any use).

An aspect of the present invention in some embodiments therefore relates to a method of retrofitting an existing tank for reducing ingestion across an interface.

An aspect of the present invention in some embodiments therefore relates to a tank for mixing a liquid with reduced ingestion across an interface.

In some embodiments ingestion of gas into fluid is reduced at a fluid-gas interface. For example, ingestion of air may be reduced at an air fluid interface. Alternatively or additionally, ingestion of one fluid into another may be reduced at a fluid—fluid interface.

In some embodiments the tank is divided into two zones. Optionally, a first zone includes the majority of the tank volume. Optionally the first zone includes a source of mixing energy. A second zone optionally includes the interface.

In some embodiments, the first zone may include for example between 50 to 75% of the active tank volume and/or between 75 to 90% of the active tank volume and/or between 90-95% and/or more than 95% of the active tank volume. In some embodiments a tank may have a volume ranging between 0 to 10 liters and/or between 10 to 100 liters and/or between 100 to 500 liters and/or between 500 and 2000 liters and/or between 2000 and 5000 liters and/or between 5000 and 20000 liters and/or greater than 20000 liters.

In some embodiments, the divider may be movable to change the volume of the first zone. For example, when a small quantity of fluid is being reacted and/or a small retention time is desired, the divider may be moved to reduce the size of the first zone. For example, when a large quantity of fluid is being reacted and/or a large retention time is desired, the divider may be moved to increase the size of the first zone. Optionally the size of the second zone may be controlled in operation, for example, by adjusting the fluid level in the tank. For example the active volume of the tank may be increased by increasing the water level in the tank (for example by raising an outlet weir). For example, the volume of the second zone may be increased by raising the height of the fluid level in the tank over the level of the divider and/or by lowering the divider. For example, the divider may be positioned to achieve a desired volume of the first zone and the water level above the divider may be set to achieve a desired volume of the second zone. In some embodiments, the divider and/or fluid level may be adjusted during operation of the tank.

In some embodiments, various design considerations may be achieved. For example, energy transfer may be inhibited between the first and second zone, for example by means of a divider. For example the divider may interfere with flow and/or energy advection and/or dispersion from the first zone to the second zone. For example, the divider may be placed to obstruct a mean flowpath which without the divider would pass from the first zone to the second zone. For example, the divider may be place across an upflow zone of the uninterfered mean flow (the mean flow that would occur in the tank without the divider). For example, the divider may reduce flow from the first zone to the second zone by between 20 to 50% and/or by between 50 to 75% and/or between 75 and 90% and/or more than 90%.

In some embodiments, a passageway is provided for material transport between the first and second zone. For example, the passageway may be configured to maintain substantial uniformity between the contents of the first and second zone. Alternatively or additionally, the passageway maybe configured to maintain a desired mixing time between the first and second zone. Optionally, the passageway may be configured so that under tank operating conditions, the mixing time of the second zone is less than a required mixing time of the process taking place in the tank. For example, the mixing time between the first and second zone may be defined as Vₜ/Qₘ where Vₜ is the volume of the second zone and Qₘ is the mixing flow rate between the first and the second zones. For example, interfering with energy transfer and providing for material transport may facilitate high mixing (for example due to high energy dissipation rate) in the first zone and/or low entrapment across the interface (for example due to low energy dissipation rate) in the second zone. Optionally the passageway and the divider may be configured to achieve a specified range of energy transfer and/or material transport.

In some embodiments, the bulk energy dissipation rate in the first zone may be between 2 to 4 times and/or between 4 to 10 times and/or between 10 and 50 times and/or more than 50 times the bulk energy dissipation rate in the second zone. Optionally flow in both regions may be turbulent. Alternatively or additionally, flow in the second zone may be laminar.

In some embodiments (for example for tanks including a liquid air interface) a design parameter to be achieved may include a limitation on the bulk energy dissipation rate in the second zone. For example, the bulk energy dissipation rate in the second zone may be preserved at a level below a minimum aeration limit (MAL). For the sake of the current disclosure the MAL may be the energy level above which a significant numbers of air bubbles begin to be captured. For example, the energy level at which the trapped air bubbles cause a turbidity that can easily be seen. For example the MAL may be the energy level at which trapped air significantly downgrades an industrially significant process (for example by causing oxidation of reactants and/or producing crud and/or interfering with settling).

In some embodiments, the source mixing energy may be configured to supply an average energy input to the tank ranging between 1.0 to 2.0 W/kg. Alternatively or additionally, the energy input into the tank may range between 2.0 to 4.0 W/kg and/or be greater than 4 W/kg.

2) Dividers

An aspect of some embodiments of the current invention relates to interfering with energy transfer between the first and second zones of a tank. Optionally interfering with energy transfer includes installing a divider between the first zone and the second zone. The divider is optionally configured to obstruct a flowpath between the zones. For example the divider may obstruct a flowpath that is directed across a boundary between the two zones. For example the divider may be located where the mean flow in the first zone is towards the second zone and/or towards the interface. For example, when the interface is at the top of the tank (for example an interface between liquid in the tank and a gas above the liquid) the divider may be place in an upflow region of the first zone. For example, the divider may cause the mean flow to be directed substantially parallel to the boundary between the first and second zones. For example, mean flow perpendicular to the boundary between the zones may be obstructed and/or redirected and/or interfered with and/or avoided. Alternatively or additionally the divider may be placed in a region of flow away from the interface, for example a downflow region.

In some embodiments a divider may include a passageway for material transport between the first and the second zones. For example an opening may be provided in the divider. For example, the opening may be located where the mean flow perpendicular to the boundary is small. For example the opening may be located where the mean flow is substantially parallel to the boundary between the first and second regions, for example at an angle between 0° to 5° and/or between 5° to 20° to the boundary. For example the opening may be located in a region of weak mean flow. For example, the opening may be located where the magnitude of the time averaged velocity is less than 10% and/or between 10 to 30% of the average magnitude of the time averaged mean velocity in the first zone. The opening is optionally configured to increase uniformity of the fluid between the first and second regions.

In some embodiments baffles may be provided. For example baffles may be provided in the first zone to inhibit and or limit tangential (rotational) mean flow. Optionally, baffles are provided in the second zone to preserve slow mean flow in the second zone. Optionally baffles prevent and/or reduce formation of a vortex in the mean flow, for example a central vortex. Optionally a baffle inhibits development of vortexes perpendicular to the interface.

3) Net Flow Between Zones

An aspect of some embodiments of the current invention relates to designing a passageway for material between a first zone and a second zone. For example the passageway may be configured to increase material transport and/or uniformity between the first and second zones and/or to reduce the mixing time of the second zone. Optionally the mixing time of the second zone will be controlled to be less than a required mixing time of a process occurring in the tank. Optionally, the passageway will be configured preserving energy transfer across the interface below an allowable level. For example, for an air-liquid interface, the second zone may be preserved below MAL. Optionally the passageway will be configured to keep an energy dissipation rate in the second zone below a threshold. Optionally the passageway will be configured to increase the difference between the rates of energy dissipation in the first and second zones.

In some embodiments there may be no net flow between the two zones (Q=0). For example the tank may be a batch reactor with no external circulation and/or the tank may be a continuous reactor wherein the inflow in each zone is equal to the outflow of that zone. For example, material transport and/or energy transfer between the regions may include diffusion (here the word diffusion may include both Brownian diffusion and/or turbulent diffusion). Alternatively or additionally, there may be a net flow Q≠0 between the first and second zones. For example, a tank may be continuous flow reactor with net fluid influx Q into one zone and net fluid outflux Q from the other zone and fluid transfer at rate Q between the zones. For example the tank may be a batch reactor with external circulation. Material transport and/or energy transfer between the regions optionally include diffusion, and/or advection (herein advective mass transport may include the mass transported in the net flow between the regions; advective energy transfer may include turbulent energy carried in the net flow between the regions and/or the mechanical energy of the net flow).

In some embodiments a rate of mass transport and/or a rate of energy transfer between zones may be adjusted during operation. For example, the rate of mass transport and/or energy transfer may be controlled by changing an inter-zone flow rate. For example, the inter-zone flow rate may be changed by adjusting a balance on inflow and outflow between zones and/or by changing a rate of external circulation. Optionally, feedback is supplied. For example, feedback may be supplied by a turbidity measuring sensor and/or an ultra sound reflection bubble detector and/or by visual observation. When ingestion is detected (for example when turbidity and/or bubble density is higher than a threshold value), then the inter-zone flow may be adjusted to reduce ingestion (for example by reducing advective transport of mechanical energy from the first zone to the second zone). Optionally a controller may receive output of said sensor and adjust said inter-zone flow rate according to said output.

4) Optional Features and Observations

Many processes may be impaired by air ingestion by liquids in agitated vessels. For example in the chemical industry, adverse effects of contact with air include reactant and product oxidation, contamination with by-products generated by side reactions and change in the physical properties of liquids. Some processes exhibit better performance when ingestion of air is prevented.

To reduce oxygen ingestion, an inert gas oxygen depleted blanket may be supplied to some tanks. Some processes that are sensitive to air are operated in hermetically tanks.

For example, for many solvent extraction processes (SX), air ingestion may be associated with degradation of the expensive extractants. The degradation products, in turn, may increase the viscosity of the organic phase and/or reduce interfacial tension; these changes may reduce the performance of separators, for example gravitational settlers. In addition, the ingested air may promote bacterial and fungal growth in a Cu SX circuit or in the leach pad and/or increase crud formation (Ritcey 1980). In some tanks, the presence of oxygen may promote oxidation of Fe2+ to Fe3+, which may stabilize emulsions (Liu et al., 2002) and/or make separation difficult.

Air ingestion may be by means of slow diffusion across an interface and/or by means of entrainment, for example capture and/or entrapment of small air bubbles by turbulent vortices. Entrainment of bubbles, if it occurs, increases dramatically the area of the contact surface between the liquid and the air, intensifying each of the processes described above.

To avoid entrainment of air in mixing tanks, mixing energy may sometimes be added far away from an interface. For example, in a tank with an upper air—liquid interface mixing energy may be added (for example by an impeller, jet, ultrasound and/or magnetic mixing source located) in the lower part of the mixing tank Distancing the energy source from the liquid surface may reduce disturbance at the surface. The mixing may be gentle (using low mixing energies) for the same reason. A lid may be installed in the tank just below the surface of the liquid and/or a floating cover may be deployed at the liquid surface.

To reduce the effects of oxygen ingestion, the products of degradation may be removed from the organic phase by treatment with activated carbon. Solvents may be modified to reduce vegetation (fungi and other microorganisms) growth and/or to produce less crud.

In some applications intensive mixing is desirable. For example, increasing mixing intensity may facilitate shorter residence time to achieve a desired mixing. Reducing residence time may be associated with reduced volume of the required vessel and/or increasing process efficiency. In some embodiments, intensive mixing results in efficient mass transfer and/or heat transfer between phases and/or prevents phase separation and/or prevents dead zone formation etc. For example, Braginsky and Kokotov (1997) have shown that in some cases of mixing of two immiscible liquids, intensive homogeneous turbulent mixing creates a narrower distribution of droplet sizes, which improves the subsequent separation of phases.

In some embodiments the present invention relates to a system to suppress air bubble capture at an interface, for example at a surface of a liquid. In some embodiments, aggressive stirring occurs in almost the entire volume. Experiments indicate that for some embodiments of the present invention the impeller rotation speed and/or rate of energy dissipation where significant numbers of air bubbles begin to be captured (minimum aeration limit or MAL) is much higher than for similar tanks built according to conventional engineering considerations. A mathematical model was developed to estimate the increase of MAL as a function of the system design parameters and process characteristics. Use of the model is illustrated in a laboratory scale example for batch and continuous flow systems.

There may be several different mechanisms ingestion at an interface. For example in a rotating liquid for example impeller stirred vessel without baffles, air can enter the liquid via a central vortex. Bubbles may be entrapped by local vortices. Entrapment by local vortexes may be the dominant form of air ingestion for example when baffles inhibit rotational flow. More intensive turbulence near the surface may correlate with more frequent capture of bubbles (Barabash et al. 1987). Near-surface turbulence may correlate with the turbulent dissipation in bulk. Dissipation in the bulk may correlate with average turbulent energy dissipation rate.

5) Application to Vertical Mixing Vessels

Some embodiments of the present invention relate to a vertical cylindrical tank mixing tank, for example a vertical cylindrical baffled mixing tank with an impeller. In some embodiments of a vertical mixing tank, turbulence may be transferred by flow between zones, for example axial flow. Optionally the volume of the tank may be divided into two zones. A first lower zone may be provided with a desired level of mixing and/or higher turbulence. The fluid surface (air-fluid interface) may be included in a second upper zone. The second zone may have a lower level of turbulence. Optionally, strong vortices near the surface, and/or the volume of air ingested into the liquid will be greatly reduced.

In some embodiments, we will reduce the volume of the upper part of the tank where the turbulence is low. Reducing the low turbulence volume may increase the effective volume being mixed. Optionally mass transport is provided between the two zones. Mass transport between the zones may tend to reduce difference between in reaction conditions between the zones, for example temperature and/or concentrations of reactants. In some embodiments maintaining desired reaction conditions in both zones of the tank may reduce side reactions and/or solids may build up etc. A passageway may be provided in the divider separating the two zones. The divider may prevent intensive transfer of turbulence from the lower first zone to the upper second zone. The passageway may provide for material transport to maintain desired reaction conditions in both zones. The design of the divider and/or the mass transport passageway may depend on the specific properties of the mixing system: for example, the physical properties of liquids being mixed, the flow pattern, the energy input and/or the intensity of turbulence. Optionally a mathematical model may be used to select design parameters and scaling based on tank parameters.

In some embodiments, the first zone may be agitated by an impeller. In some embodiments, the impeller will create axial flow. For example there may an upflow region around the periphery of the tank. The flow path of the upflow region may be up axial from the lower zone towards the upper zone and/or towards the fluid surface. In some embodiments there may be a downward flow region along the central axis of the tank. For example the divider may include a peripheral baffle with obstructing flow between zones in peripheral region, for example along the walls of the tank. A passageway for transport between zones may be formed in the central portion of the divider. For example the divider may have an annular form. For example the peripheral baffle may have a width ranging between ⅕ to ¼ the radius of the tank and/or ¼ to ½ the radius of the tank and/or greater than ½ the radius of the tank. In baffled tanks the width will optionally be greater than ⅓ the radius of the tank. In some embodiments the annular baffle will be attached to the walls of the tank. Optionally peripheral flow along the wall flow perpendicular to the annular baffle will be substantially obstructed. The term radius may be used to refer to the hydraulic radius, for example in non-circular geometries.

In some embodiments, a material transport passageway may include an opening in the central section of the annular divider. In some embodiments, a central baffle may interrupt a downward vortex from the fluid surface. The central baffle is optionally mounted at a height similar to the annular baffle. For example the central baffle may be mounted on a shaft, for example the impeller shaft. Alternatively or additionally the central baffle may be supported by and/or included on the annular divider. Interrupting a vortex optionally includes reducing the length (e.g. depth of penetration of the vortex). For example, central baffle may reduce a central vortex to between 0 to 10% and/or 10 to 40% and/or 40 to 80% of the length of the central vortex without the central baffle. Alternatively or additionally the central baffle may interrupt flow along a central vortex between the first and second zones. Alternatively or additionally the central baffle may block the central vortex from penetrating from the second zone to the first zone.

In some embodiments, baffles are included in second zone of the tank. In some embodiments, the first zone may include baffles. For example, baffles in the first zone of the tank may reduce tangential flow.

In some embodiments, of a vertical mixing tank the division of volume of the tank between the two regions and/or the energy dissipation rate and/or the design consideration and/or the ratio of bulk energy dissipation rate between zones and/or the average power input and/or other aspects of the vertical cylindrical tank may be as described herein above in general and/or herein below in various exemplary embodiments.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### EXEMPLARY EMBODIMENTS

1) Method of Reducing Ingestion

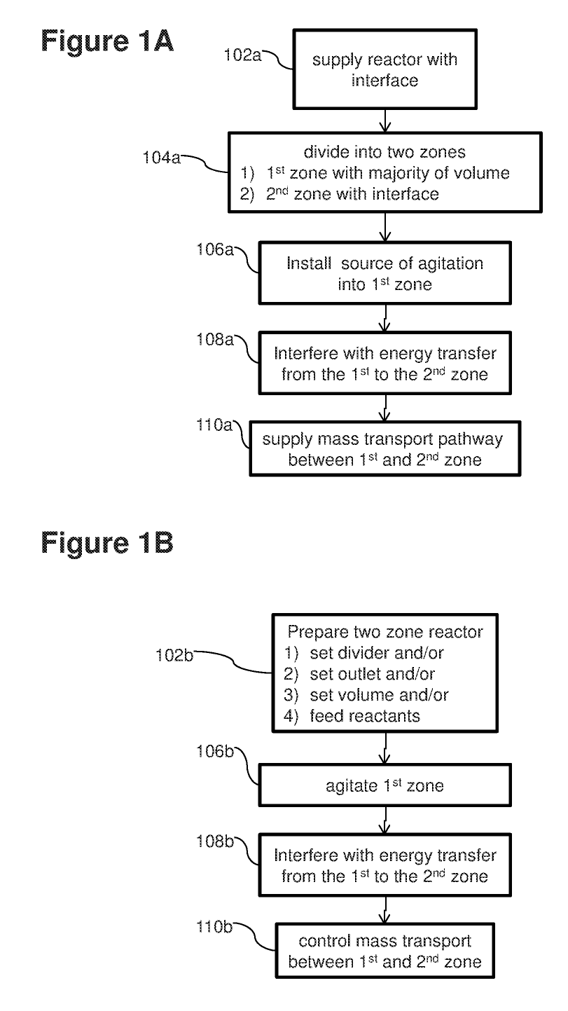

FIG. 1A is a flowchart illustration of a method of reducing ingestion across an interface in accordance with some embodiments of the present invention. In some embodiments, a tank having an interface is supplied 102a. For example supplying 102a the tank may include building a new tank and/or retrofitting an existing tank. Optionally the tank is divided 104a into at least two zones, for example a large first zone and/or a smaller second zone, for example as described herein above and/or below. The interface is optionally located in the second zone.

In some embodiments, a source of agitation and/or mixing energy may be installed 106a into the first zone. Installing 106a an energy source optionally includes installing a new impeller and/or replacing an old impeller and/or adjusting an existing impeller and/or installing, replacing, and/or adjusting a motor and/or installing, replacing and/or adjusting a fluid jet and/or inlet and/or installing, replacing and/or adjusting other mixing energy sources. Optionally, the energy source is configured to supply a desired mixing power, for example as described herein above and/or below.

In some embodiments energy transfer between the zones may be inhibited. For example, inhibiting energy transfer may include interfering 108 with energy transfer, for example by dividing 104a the first zone from the second zone. For example, dividing 104a the tank and/or interfering 108a with energy transfer may include placing a divider. The divider is optionally placed along a flow path between the first zone and the second zone. For example, in a tank with a free surface air-liquid interface, the divider may be placed in an upflow region of the first zone.

In some embodiments, a mass transport passageway may be supplied 110a between the first zone and the second zone. The mass transport passageway is optionally configured to achieve a desired uniformity of reagents between the first and second zones, for example as described herein above and/or below. The mass transport passageway is optionally configured to achieve a desired difference between energy dissipation rate between the first and second zones, for example as described herein above and/or below.

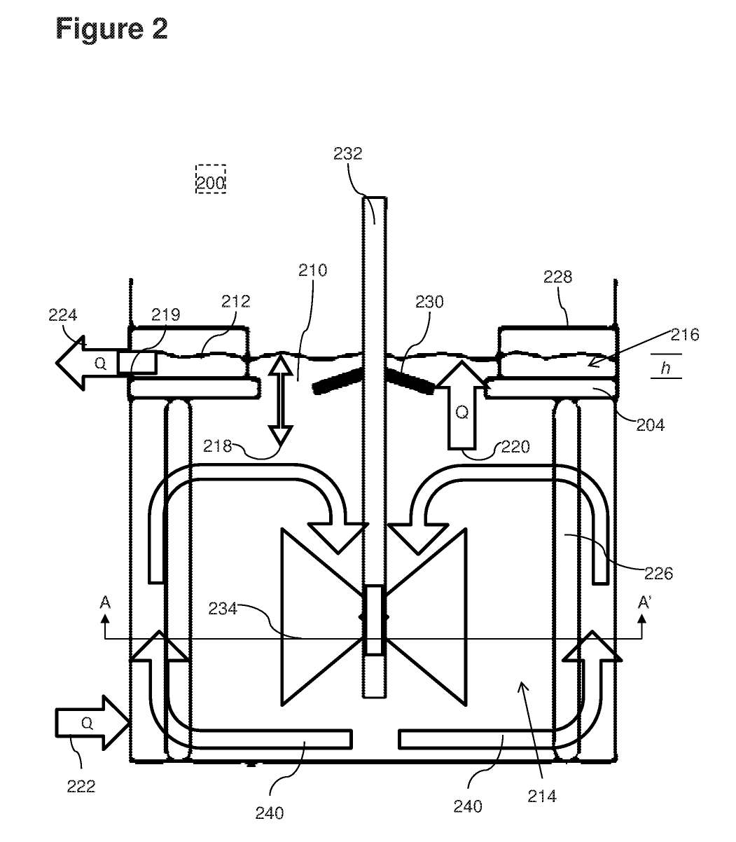

FIG. 1B is a flowchart illustration of a method of operation of a mixing tank reducing ingestion across an interface in accordance with some embodiments of the present invention. In some embodiments, the two zone tank may be prepared 102b for use. Optionally preparing 102b the tank may include adjusting a divider between the zones. Optionally, the adjusting may be according to the quantity and quality of the reactants and/or the intensity of mixing. For example, when a large quantity of reactants will be used and/or a large retention time is desired the divider may be moved to increase the volume of one or more of the zones. For example, for a tank having a divider between a lower first zone and a higher second zone and/or a fluid—gas interface at the top of the second zone, the divider may be raised to increase the volume of the first zone, for example as explained below with respect to FIG. 2A. Alternatively or additionally the divider may be replaced or adjusted. For example the size and shape of the divider may be adjusted to achieve a desired level of energy transfer and/or mass transport for the parameters of the process for example as explained herein below. For example the mass transfer passageway may be made smaller for a more vigorously agitated reaction. Alternatively or additionally, preparing 102b the tank may include adjusting a tank volume. For example, the outlet may be adjusted according to the location of the divider and the desired volume of the second zone. For example, for a tank having a divider between a lower first zone and a higher second zone and/or a fluid—gas interface at the top of the second zone, an overflow fluid outlet may be raised to increase the volume of the second zone and/or lowered to decrease the volume of the second zone, for example as explained below with respect to FIG. 2A. Alternatively or additionally, preparing 102b the tank may include feeding reactants into the tank. For example in a batch process the volume of the tank and/or of the second zone may be controlled by the feeding of the reactants, for example as explained below with respect to FIG. 2A.

In some embodiments the first zone may be agitated 106b. The agitation energy and/or geometry in the first zone may be adjusted to achieve one or more desired characteristics including for example a desired mixing regime, a desired energy transfer between zones, and/or a desired mass transfer between zones.

In some embodiments energy transfer between the zones may be inhibited. For example, inhibiting may include interfering with 108b energy transfer. For example interfering 108b with energy transfer may include preparing 102a the tank, for example as described herein above.

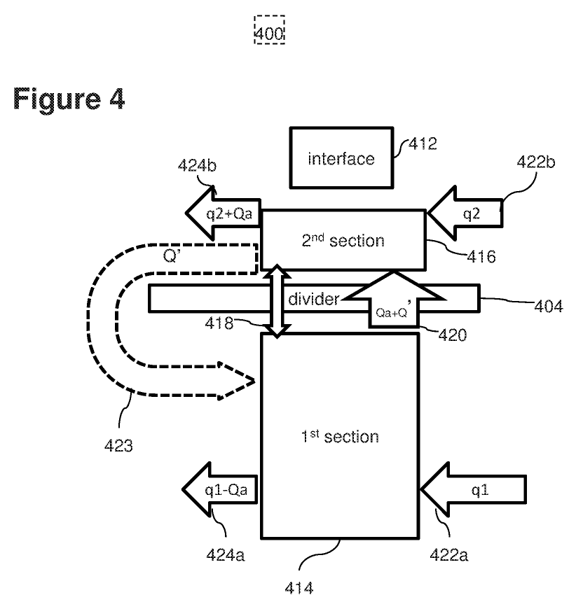

In some embodiments, a mass transport passageway may be supplied 110a between the first zone and the second zone. The mass transport passageway is optionally configured to achieve a desired uniformity of reagents between the first and second zones, for example as described herein above and/or below. Alternatively or additionally an amount of mass transport and/or energy transfer between the zones may be controlled 110b by adjusting the rate of reactant feed and/or drain and/or cross divider flow rate Q, for example as explained herein below with respect to FIG. 4.

2) Vertical Mixed Tank

FIG. 2 is a schematic illustration of a vertical mixing tank 200 in accordance with some embodiments of the present invention. Tank 200 optionally includes an annular divider 204. Divider 204 separates an agitated highly turbulent first lower zone 214 from a reduced turbulence second upper zone 216. For example, divider 204 may obstruct upward flow from lower zone 214 towards an air—liquid interface 212. An optional passageway 210 is located in the central portion of annular divider 204. Passageway 210 optionally provides for mass transport between zones 214 and 216.

In some embodiments, an impeller 234 located in lower zone 214 imparts mechanical mixing energy to the system. Optional baffles 226 in lower zone 214 obstruct tangential flow. For example, mean flow in lower zone 214 is primarily axial (downwards in the center and upwards around the edges) as illustrated by arrows 240. Optionally, annular divider 204 obstructs the upflow region around the edges of tank 200. For example, divider 204 obstructs upflow from lower zone 214 to upper zone 216. Optionally, inflow 222 into the system is at a rate Q into lower zone 214 and/or outflow 224 is through an overflow weir 219 located in upper zone 216. By mass balance and/or incompressible fluid volume, at steady state outflow 224 is at rate Q (equal to the inflow rate) and there is an inter-zone flow 220 at a net rate Q from lower zone 214 to upper zone 216. Inter-zone flow 220 passes through a passageway 210. In some embodiments, inter-zone flow 220 transports material (and/or heat etc.) and/or transfers mechanical energy from lower zone 214 to upper zone 216 (for example by means of advection). In some embodiments, inter-zone material transport and/or energy transfer may also occur by dispersion 218 across passageway 210. Dispersion 218 may include for example molecular diffusion (for example Brownian motion) and/or turbulent dispersion (for example due to transport by turbulent eddies).

In some embodiments a central baffle 230 may be provided. Central baffle 230 optionally interrupts formation of a central vortex and/or blocks a central vortex from crossing zones, for example from second zone 216 to first zone 214. For example, a central vortex may be a vortex formed in the mean flow. Optionally, central baffle is connected to a shaft 232 of impeller 234. For example, central baffle 230 may rotate with shaft 232. Optionally, central baffle is tilted downward (for example like the top surface of a cone). Optionally, baffles 228 are provided to reduce flow in upper zone 216.

In some embodiments, the volume of lower zone 214 and/or upper zone may be adjustable. For example, divider 204 may have an adjustable height. Optionally, raising the height of divider 204 increases the volume of lower zone 214. Optionally, lowering the height of divider 204 decreases the volume of lower zone 214. For example, weir 219 may have an adjustable height. Optionally, raising the height of weir 219 increases the volume of upper zone 216. Optionally, lowering the height of weir 219 decreases the volume of lower zone 216.

In some embodiments, performance of a tank may be predicted and/or controlled using an approximately mathematical model. The model may use approximations based on the Kolmogorov model of homogeneous isotropic turbulence is applicable.

For example we may connect an approximate local energy dissipation rate ε₁ (W/kg) with mean pulsation velocity vₚ₁ of scale λ1; where λ₁ is a characteristic length using the relationship:

ε₁=vₚ₁³/λ₁ Eq. 1

The method of calculation of energy dissipation rate may be similar to calculations presented in Braginsky and Kokotov, Kinetics of Break-Up and Coalescence of Drops in Mixing Vessels. International Symposium on Liquid-Liquid Two Phase Flow and Transport Phenomena, Antalya, Turkey, 1997, pp. 567-574. The characteristic length λ₁ may be approximated as proportional to the width of peripheral upflow zone B multiplied by the coefficient 0.4 (Braginsky L. N., Begachev V. I., Barabash V. M. (1984) Mixing of liquids. Theoretical basements and methods of technical calculation. Himia Publishers, Leningrad). For a vertical cylindrical tank mixed by an impeller and having baffles (for example similar to tank 200) the approximation B=0.3R may be used where R is the radius of the tank. Based the above approximation, the value of the characteristic length is λ₁=0.4·(0.3R)=ξR. The constant ξ=0.12 may be adjusted using experimental data for this specific application, if necessary.

For the sake of simplicity we base our calculations on the supposition that the level of turbulence in upper zone 216 is substantially lower than in the lower zone 214. Below we summarize the turbulent energy entering upper zone 216. For an approximately steady state, the total energy transfer through annular passageway 210 (between central baffle 230 and annular divider 204) is approximately equal to the total energy dissipation in the upper zone is:

F_{T1}+F_{R1}+F_{C1}=V₂ε₂ Eq. 2

Where F_{T1}=T₁·(Q+s·vₚ₁/2) is the turbulent energy transfer due to convection and turbulent pulsations; and T₁=ρvₚ₁²/2 is the kinetic energy of pulsations; F_{R1}=0.5ρvₜ²·(Q+s·vₚ₁/2) is the energy of tangential motion transfer due to convection and turbulent pulsations; F_{C1}=ρv_{c}²/2·Q is the kinetic energy of the flow through passageway 210; v_{c}=Q/s is the linear velocity at passageway (s is the cross sectional area of the passageway, for example in tank 200 the area of the annular orifice). Optionally we may define a mixing flow rate between the zones as the rate of fluid transfer between the zones Qₘ=vₚ₁·s/2.

Therefore, the mean energy dissipation rate in the upper zone is

$${ɛ}_{2} = \frac{2}{π {h}_{2} {D}^{2}} [ ( Q + \frac{1}{2} s \cdot {v}_{p 1} ) ( {v}_{p 1}^{2} + {v}_{τ}^{2} ) + \frac{{Q}^{3}}{{s}^{2}} ] \qquad Eq .3$$

We define the area of horizontal cross-section A=πR², K=1+v_{τ}²/vₚ₁² and superficial velocity w=Q/A. Rotational velocity v_{τ} and consequently K can be calculated according to the hydrodynamic model described by Braginsky L. N., Begachev V. I., Barabash V. M. (1984) Mixing of liquids. Theoretical basements and methods of technical calculation. Himia Publishers, Leningrad. Applying Eq. 1 we derive the ratio of dissipation energies in upper and lower zones:

$$\frac{{ɛ}_{2}}{{ɛ}_{1}} = \frac{ξ}{4} \frac{D}{{h}_{2}} [ K ( \frac{w}{{v}_{p 1}} + \frac{1}{2} \frac{s}{A} ) + {( \frac{w}{{v}_{p 1}} )}^{3} {( \frac{A}{s} )}^{2} ] = \frac{ξ}{4} \frac{D}{{h}_{2}} {f}_{2} ( \frac{s}{A} , K , \frac{w}{{v}_{p 1}} ) , {f}_{2} = \frac{{ɛ}_{2}}{{ɛ}_{1}} \frac{4 {h}_{2}}{ξ D} \qquad Eq .4$$

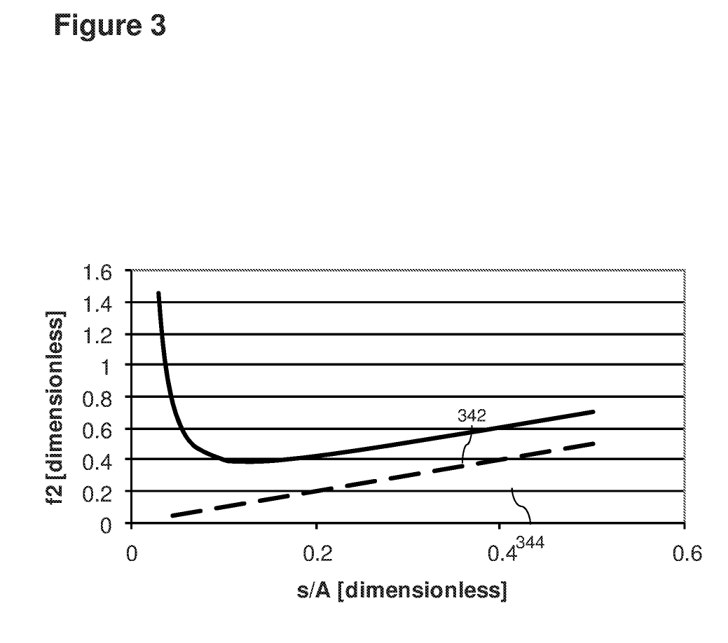

In FIG. 3 we show the calculated influence of the area of the orifice on the dissipation energy ratio. As we see, ε₂/ε₁ depends significantly on the ratio s/A, and the parameters of this dependence are K, w/vₚ₁ and ξD/(4 h₂). As illustrated byError! Reference source not found., the curve has a minimum for continuous processes. This means that there exists an optimal of the opening that minimizes turbulence near the surface for any given configuration of the process and the mixing system.

In some embodiments, the following practical design considerations may be used for a vertical mixing tank. The divider (for example divider 204) may substantially obstruct flow from the lower zone to the upper zone in the upflow region. For example the divider may cover a region including an annulus around the tank edges of width 0.3R. The depth h from the liquid surface to the top of the divider range between 1/25 and ⅕ of the total depth of fluid in the tank. The central baffle will optionally be located at a height equal to the divider or slightly below, for example within the range from 1/25 to ⅕ the total depth of fluid in the tank. Alternatively or additionally, the central baffle may be slightly above the divider.

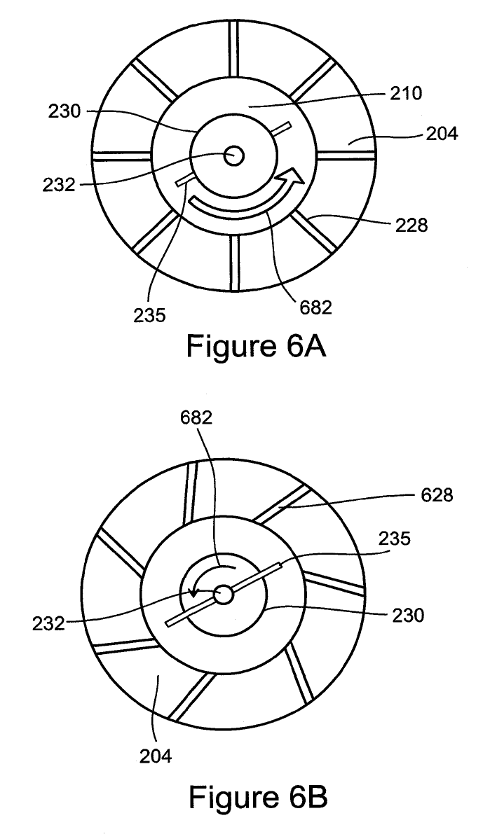

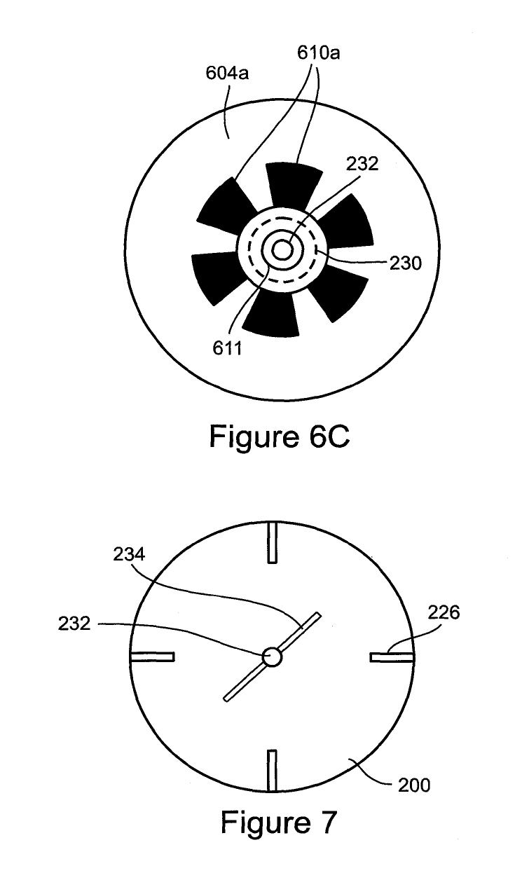

In some embodiments the cross sectional area s of the passageway between the upper and lower zones may range between 16 h(A/π)^{0.5}/K<s<21 h(A/π)^{0.5}/K. Alternatively or additionally s may range s<16 h(A/π)^{0.5}/K; where A is the area of the interface. For example for a circular cylindrical vessel (for example as illustrated in FIGS. 2, 6A and 6B), A=πR². In some embodiments a tank may have a rectangular cross section and/or be in the form of an inclined (for example horizontal) cylinder, spherical, conical and/or of another shape. In some embodiments a tank may have more than one impeller. Optionally, for each geometry, ingestion may be prevented as described above. For example, for each tank geometry, a divider may be placed to obstruct a zone of flow from the highly mixed zone towards the interface. For example in each embodiment the passageway cross sectional area s may conform to the relationships above (for example with the cross sectional area of the interface).

3) Ratio of Dissipation in Upper and Lower Zones of a Vertical Mixing Tank

FIG. 3 illustrates dependence of the dissipation energy ratio between two zones on the orifice area (cross sectional area of a passageway between the zones) calculated as described above according to some embodiments of the current invention. For this calculation the following data were used: w/vₚ₁=0.1 for line 342 and w/vₚ₁=0 for line 344, v_{τ}/vₚ₁=1,K=2. In some embodiments (for example corresponding to line 344 and/or a batch processes without recycling and/or a continuous flow system where in each zone the fluid input and output are equal [for example as described in the explanation of FIG. 4]) Q=0 the theoretical optimal solution is a fully closed cover (s/A=0 at w=0). In many cases for Q=0, an annular baffle (for example as illustrated in FIG. 2) is a practical geometry. In practice designs may be based on trade-offs between process demands, equipment cost and reducing of the air intake.

For example, condition and corresponding value of minimum energy dissipation in the upper zone based on the specific parameters of mixing and volume of the upper zone are

$$\frac{s}{A} {\vert}_{{ɛ}_{2} \to min} = {( \frac{4}{K} )}^{1 \text{/} 3} \frac{w}{{v}_{p 1}} ; \frac{{ɛ}_{2 , min}}{{ɛ}_{1}} = \frac{ξ}{4} \frac{D}{{h}_{2}} {K}^{2 \text{/} 3} \frac{w}{{v}_{p 1}} [ {K}^{1 \text{/} 3} + {2}^{- 1 \text{/} 3} + {2}^{- 4 \text{/} 3} ] .$$

4) Tank Feed Control

FIG. 4 is a block diagram illustrated a tank 400 in accordance with some embodiments of the present invention. Optionally, the rate of air ingestion and/or the uniformity of fluid between zones in tank 400 is controlled during operation and/or without interrupting operation by control of fluid inflow, fluid outflow and/or external recirculation. Tank 400 includes two zones; a first zone 414 optionally includes a source of mixing energy. A second zone 416 optionally includes an interface 412. A divider 404 separates first zone 414 from second zone 416. There may be many mechanisms of transport of mass and/or transfer of energy between zones 414 and 416. In some embodiments, some of the parameters may be fixed (not amenable to adjustment during operation of the tank). In some embodiments, some of the parameters determining rates of inter-zone mass transport and/or energy transfer between the zones 416 and 414 are controlled during operation of the tank.

In some embodiments dispersive 418 energy transfer and/or mass transport and/or there may be advective 420 energy transfer and/or mass transport between first zone 414 and second zone 416. The rate of dispersive 418 transport and/or transfer may be dependent on a molecular and/or turbulent diffusivity of the medium and/or on the size and shape of the passageway between zones 414 and 416. The rate of advective 420 transfer and/or transport may be dependent on a rate of flow Q=Qₐ+Q′ between zone 416 and 414.

In some embodiments, (for example for reactions which do not significantly change the mass and/or volume of the reagents), the mass transfer rate between first zone 414 and second zone 416 is dependent on the balance of inputs and output of the zone. For example, tank 400 is shown with an inflow 422a at rate q1 into first zone 414 and an inflow 422b at rate q2 into second zone 416. In the example of FIG. 2, there is an external circulation flow 423 at a rate Q′ from second zone 416 to first zone 414.

In some embodiments, by mass balance (which may corresponds to a volume balance for example for an incompressible liquid) at steady state the net outflow rate of the tank may be q1+q2. Allowing for liquid flow between zones 414 and 416 we define an outflow 424a rate of first zone 414 as q1-Qₐ and the outflow 424b rate of the second zone as q2+Qₐ. For example, the mass balance net flow rate between zones 414 and 416 leads to a net inter-zone flow 420 rate of Q=Qₐ+Q′.

In some embodiments, control of the net inter-zone flow 420 rate Q=Qₐ+Q′ may be used to control ingestion across an interface (for example interface 412). For example, if a tank 400 is ingesting too much material across interface 412 then an operator may reduce the magnitude of inter-zone flow 420 |Qₐ+′|. For example for a positive inter-zone flow rate Q=Qₐ+Q′, reducing the net inter-zone flow 420 rate Q=Qₐ+Q′ may decrease the rate of energy input to second zone 416 (for example by reducing the rate of advection of mechanical energy from first zone 414 to second zone 416 and/or by reducing the energy of tangential motion transfer due to convection and/or by reducing the kinetic energy of the inter-zone flow). For example, reducing the rate of energy input to second zone 416 may decrease the rate of energy dissipation in second zone 416. For example, reducing the rate of energy dissipation in second zone 416 may decrease the rate of ingestion across interface 412. For example for a positive inter-zone flow rate Q=Qₐ+Q′, the rate Q=Qₐ+Q′ may be reduced by reducing the external circulation rate Q′. Alternatively or additionally, for a positive inter-zone flow rate Q=Qₐ+Q′, the rate Q=Qₐ+Q′ may be reduced by reducing Qₐ. Optionally, Qₐ and/or Q′ are adjusted (reduced or increased) without changing the net flow through tank 400 and/or without changing residence time of tank 400 and/or without interrupting operation of tank 400 and/or without changing size of tank 400. For example Qₐ may be changed by changes to the balance of inflow and/or outflow. For example decreasing Qₐ by changes to the balance of inflow and/or outflow may include decreasing first zone 414 inflow 422a rate q1 and increasing second zone 416 inflow rate q2 by the same amount while keeping outflow 424a, b rates fixed. Alternatively or additionally decreasing Qₐ by changes to balance of inflow and/or outflow may include increasing first zone 414 outflow 424a rate q1−Qₐ and decreasing second zone outflow rate q2 by the same amount while keeping inflow 422a, 422b rates fixed.

In some embodiments, control of the net inter-zone flow 420 rate Q=Qₐ+Q′ may be used to control uniformity of parameters between zones (for example zones 414 and 416). For example, if tank is developing an unacceptably high temperature differential and/or concentration differential between zones 414 and 416, then an operator may increase the magnitude of the inter-zone flow 420 rate |Q=Qₐ+Q′|. Increasing the net inter-zone flow 420 rate Q=Qₐ+Q′ may increase mixing and/or uniformity between the zones 414 and 416. Increasing the magnitude of inter-zone flow may be achieved for example by decreasing external circulation 423 rate Q′ and/or by changes to the balance of input (422a, 422b) and/or output (424a, 424b) flow rates, for example inverse to the balanced increase of Qₐ above.

In some embodiments, one or more zones of a tank may include an adjustable inflow rate (for example rate q1 of inflow 422a and/or rate q2 of inflow 422b) and/or outflow rate (for example rate q1−Qₐ of outflow 424a and/or rate q2+Qₐ of outflow 424b) from one or more of the zones without external circulation 423 (for example Q′=0) and/or with a fixed external circulation 423 rate (for example Q′=C). For such a tank the net inter-zone flow 420 rate Qₐ and/or Qₐ+C may be adjustable by balancing inflow and/or outflow of the various zones.

In some embodiments, one or more zones of a tank may include non-adjustable rate of inflow rates (for example rate q1 of inflow 422a and/or rate q2 of inflow 422b) and non-adjustable outflow rates (for example rate q1−Qₐ of outflow 424a and/or rate q2+Qₐ of outflow 424b) from one or more of the zones with adjustable external circulation rate (for example Q′=0) and/or a fixed external circulation (for example Q′=C). For such a tank the net inter-zone flow 420 rate Q=Qₐ+Q′ may be adjustable by adjusting the external circulation rate Q′. For example, a batch tank may have a fixed inflow and outflow of q1=q2=Qₐ=0.

In some embodiments the net inter-zone flow 420 rate may be zero. For example for a batch tank without external circulation and/or for continuous flow tank where in the inflow and outflow are balanced in each zone without external circulation and/or a batch flow tank where difference between inflow and outflow in each zone is balanced by the external circulation. For example, the inter-zone flow 420 rate Q=Qₐ+Q′ may be equal to the external circulation 423 rate Q′ in a constant flow tank having flow input and output in the lower zone 414 only (q2=Qₐ=0); in such a tank, for Q′=0 the inter-zone flow rate would be zero and/or the inter-zone flow rate may be adjusted by adjusting the external circulation 423 rate Q′.

In some embodiments some or all of the input (for example 422a and/or 422b) rates (for example q1 and/or q2) and/or output rates (for example 424a and/or 424b) rates (for example q1−Qₐ and/or q2+Qₐ) and/or the external circulation 423 rate Q′ may be adjustable. The inter-zone flow 420 rate Q=Qₐ+Q′ is optionally adjusted by adjusting one or more of the adjustable rates.

In some embodiments, inter-zone flow 420 rate can be reduced to be negative. In such a case transfer of energy dissipation from the first zone 414 to second zone 416 may be reduced. Other sources of energy dissipation may become important in the second zone 416.

In some embodiments a mixing time of second zone 416 may be controlled. Optionally the mixing time may be kept below the required mixing time for a process occurring in the tank. For example a mixing time may be defined as tₘ=Qₘ/A where the mixing flow rate Qₘ=Q′+Qₚ₁ and the pulse flow rate Qₚ₁=vₚ₁·s/2.

5) Passageway Geometries

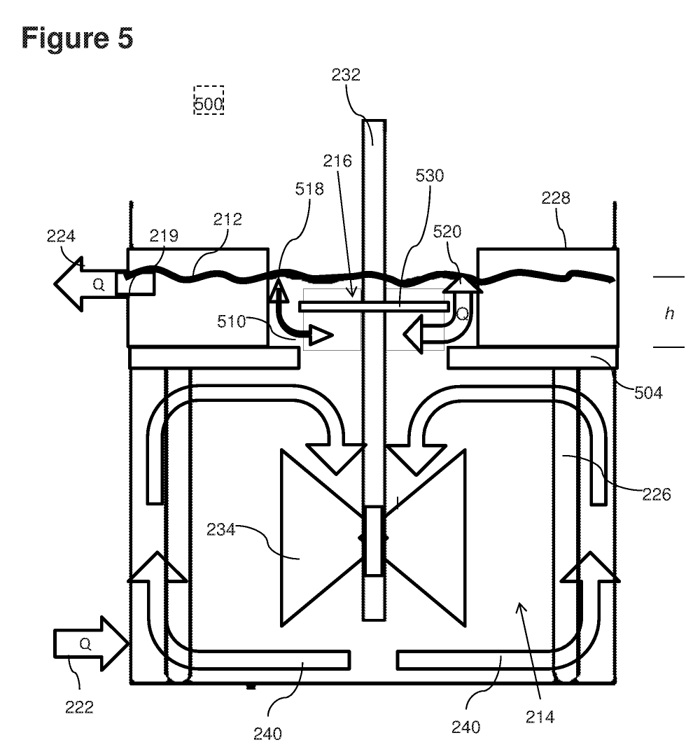

FIG. 5 illustrates an alternative geometry for a vertical mixing tank 500 in accordance with some embodiments of the present invention. In tank 500 a passageway 510 for mass transport and/or energy transfer by advection 520 and/or dispersion 518 has bent shape crossing a vertical cylindrical surface between a disk shaped central baffle 530. For the calculations above the cross section of the transport passageway 510 (s) is the surface area of the cylindrical surface (for example s=2πr_{b}² h_{b} where r_{b} is the radius of central baffle 530 and h_{b} is the vertical distance between the bottom of central baffle 530 and the top of annular divider 504. Alternatively or additionally, central baffle 530 may be conical in shape or have another convenient shape.

6) Top Down Views of a Vertical Mixing Tank

FIGS. 6A-6C are schematic illustrations of top down views of tank 200 in accordance with some embodiments of the present invention. In the embodiment of FIG. 6A baffles 228 are linear and oriented radially. In the embodiment of FIG. 6B, baffles 628 are curved and directed against the direction of rotation 682 of impeller 235. Other configurations of baffles are possible.

FIG. 6C illustrates a top down schematic view of an alternative embodiment of a divider 604a in accordance with some embodiments of the present invention. Divider optionally includes a closed peripheral section obstructing an upflow region (for example on the periphery of tank 200). For example, in the embodiment of FIG. 6C, passageway 610a includes windows allowing mass transport and/or energy transfer across divider 604a. Optionally, impeller shaft 232 passes through a central opening 611. Below central opening 611 there is an optional central baffle 230. Optionally central baffle 230 interrupts formation of a central vortex. In the embodiment of FIG. 6C, the cross sectional area s of the transport passageway 610a may be, for example the sum of the area of the windows making up passageway 610a.

7) Non-Annular Divider

FIG. 7 is a schematic cross sectional illustration of tank 200 cut along line A-A′ (see FIG. 2) in accordance with some embodiments of the present invention.

8) Non-Vertical and/or Multiple Impeller Shafts

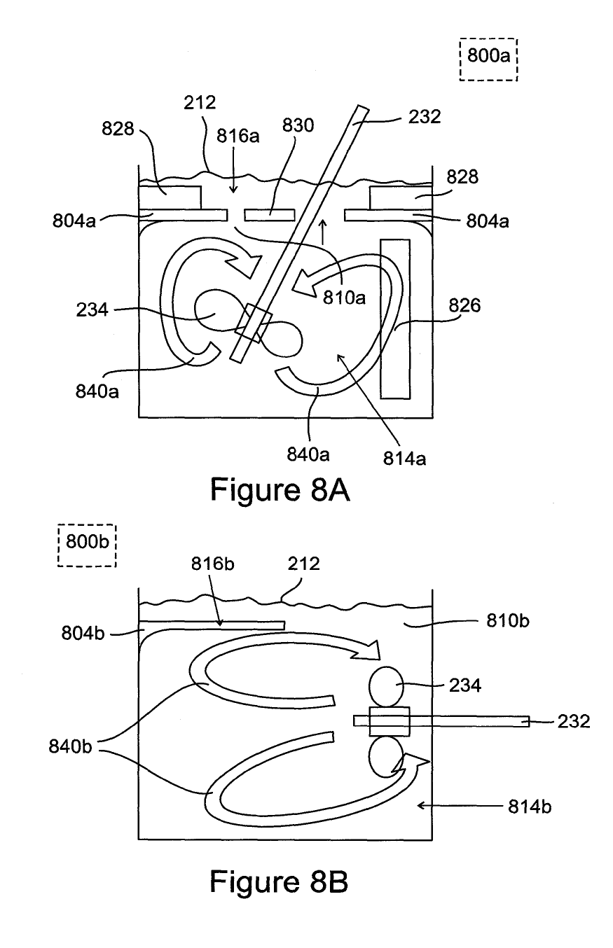

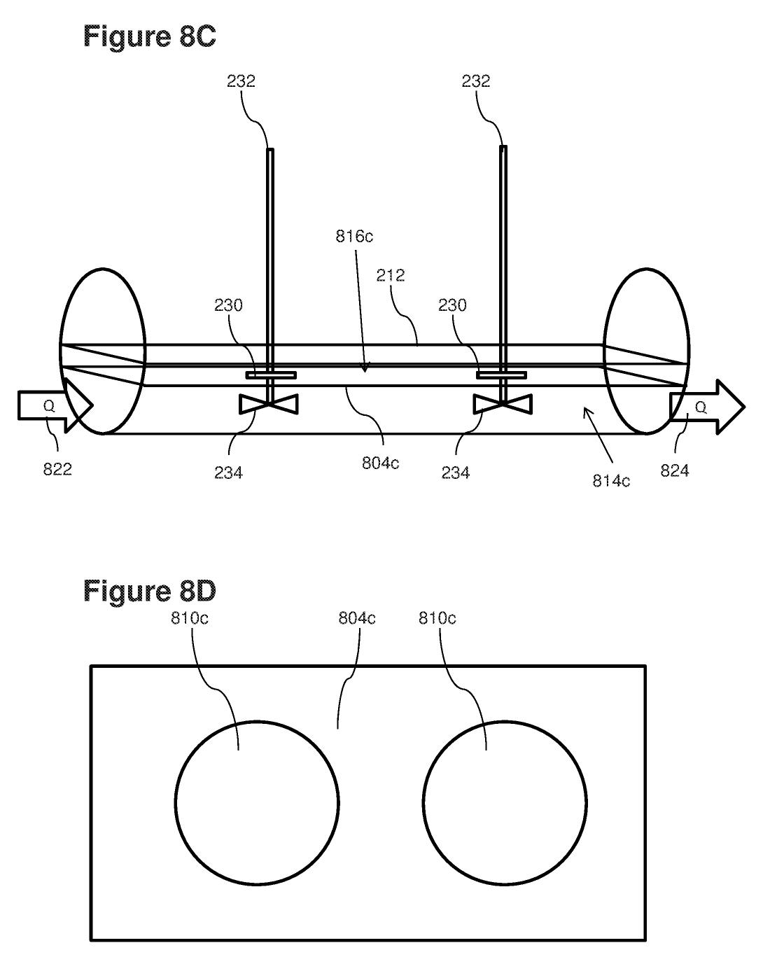

FIGS. 8A and 8B are schematic illustrations of two alternative of tanks 800a and 800b with non-vertical impeller shafts in accordance with some embodiments of the present invention. Optionally, in tanks 800a and 800b, a divider obstructs a mean flowpath 840a, 840b from a highly agitated first zone toward a less turbulent second zone including an interface. The geometry of tanks 800a and 800b may be any convenient shape, not necessarily circular.

In some embodiments, for example as illustrated in FIG. 8A, an impeller may be inserted into the top of tank 800a at a non-vertical angle. Optionally, a central baffle 830 may be included. For example, central baffle 830 may interrupt and/or hinder creation of a central vortex. A divider 804a may divide a well mixed zone 814a from a more quiescent zone 816a including an interface 212. Divider 804a may for example obstruct a flowpath 840a leading from zone 814a to zone 816a. For example, an upflow zone where flow in a non-circular tank is directed toward a free surface interface 212. A baffle 826 may optionally be placed in the highly agitated zone. For example, baffle 826 may hinder rotation flow. Optionally, baffles 828 in quiescent zone 816a may reduce rotation near the interface. Optionally a passageway 810a is provided between zones 814a and 816a. Optionally, there is mass transfer between zones 814a and 816a through passageway 810a.

In some embodiments, for example as illustrated in FIG. 8B, and impeller 234 and/or shaft 232 may be inserted through a wall of a tank into a zone 814b of highly turbulent flow. Optionally a divider 804b may divide zone 814b from a more quiescent zone 816b including an interface 212. In some embodiments, divider 804b may obstruct mean flowpath 840b from highly agitated zone 814b to quiescent zone 816b. Optionally, there is mass transfer between zones 814b and 816b through a passageway 810b.

FIG. 8C illustrates a pipe flow tank reactor in accordance with some embodiments of the current invention. For example, a pipe flow reactor may have inflow 822 at a first end of the pipe and outflow 824 at the other end. Optionally fluid is agitated by multiple impellers 234 along the length of the tank. Optionally a divider 804c divides a lower highly agitated zone 814c from a lower quiescent zone 816c. Central baffles 230 attached to impellor shafts 232 may optionally prevent development of central vortexes around shafts 232 into highly agitated zone 814c.

FIG. 8D illustrates the divider 804c of embodiment 8C from above. Divider 804c optionally obstructs flow from agitated zone 814 to quiescent zone 816c in upflow regions (for example around the edges of the tank and between the impellers). Passageways 810c are provided for mass transfer.

It is expected that during the life of a patent maturing from this application many relevant mixing apparatuses will be developed and the scope of the terms impeller, baffle, divider, tank are intended to include all such new technologies a priori.

As used herein the term “about” refers to ±5%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

9) Example—Experimental Set Up

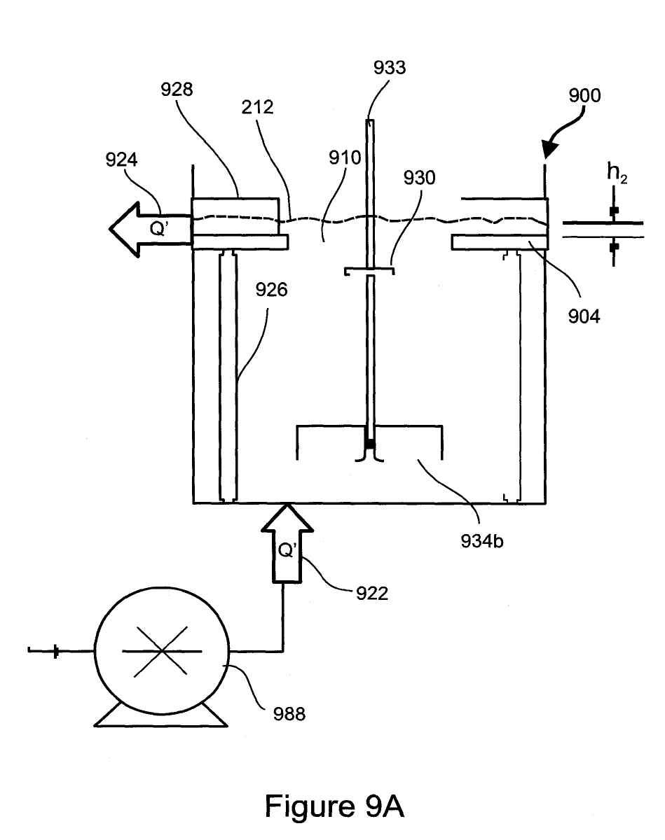

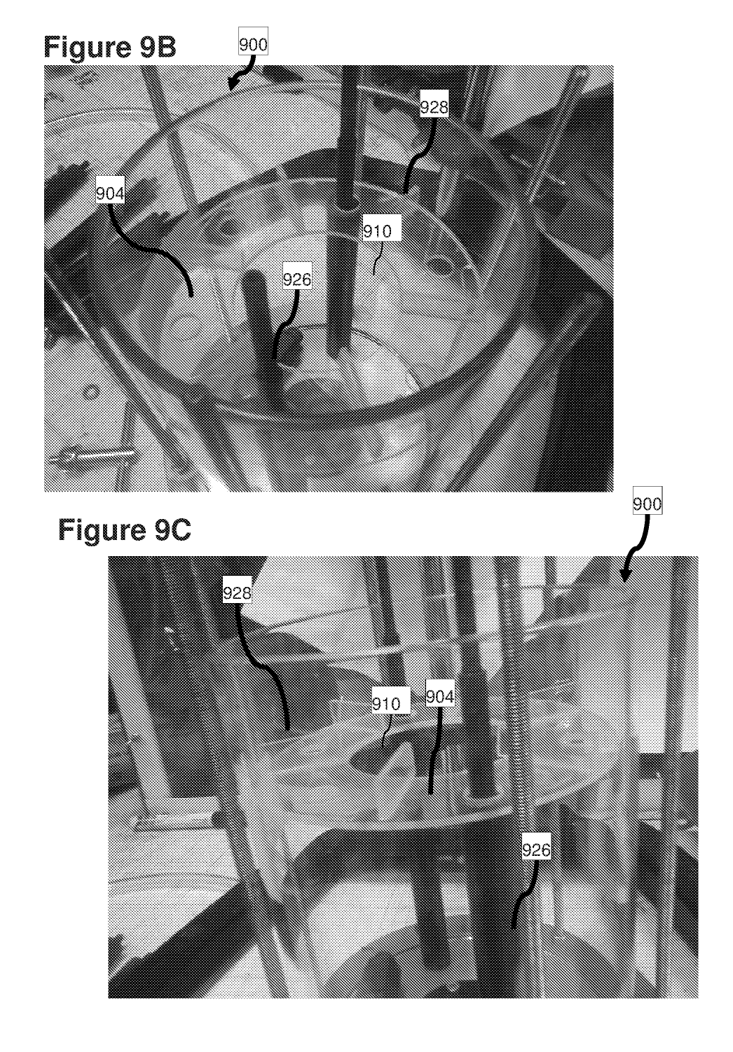

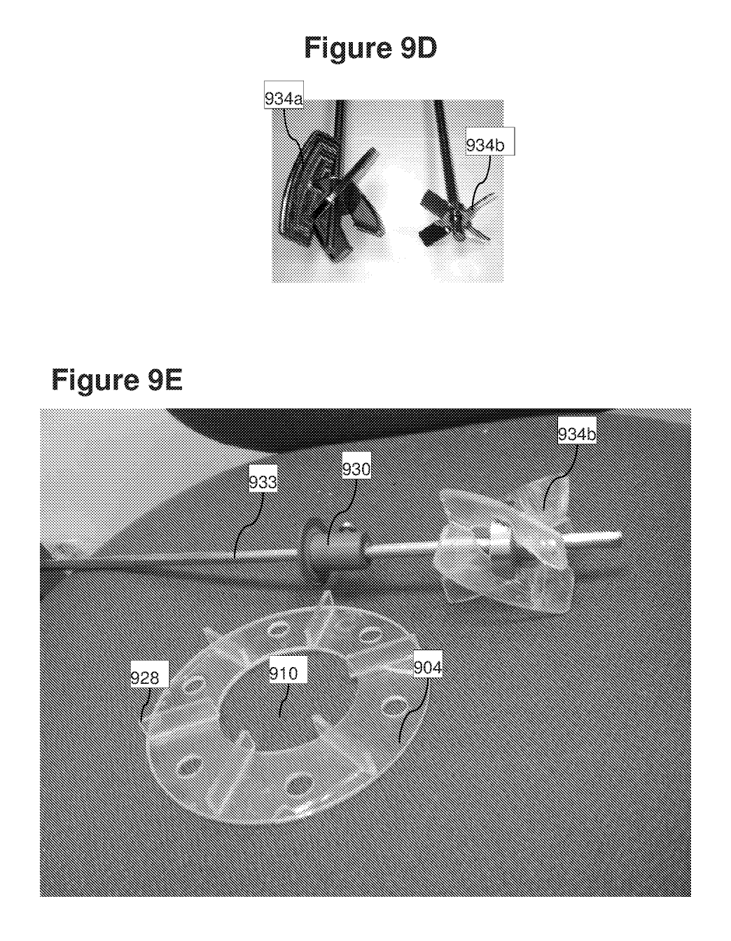

An experimental system is shown in FIGS. 9A, 9B and 9B, according to some embodiments of the present invention. The system has a glass mixing vessel 900 (143 mm internal diameter and 200 mm height) and 6 removable cylindrical baffles 926 (16.5 mm diameter and 140 mm height) that can be installed and/or removed in the mixing vessel in the lower zone below a divider 904. Radial baffles 928 are supplied in the upper zone (above divider 904). The liquid was fed 922 continuously through the bottom, and collected 924 near the surface by an outflow weir (for example an 8 mm internal diameter pipe). A positive displacement pump 988 provided variable recycling flow rates up to 1.3 L/min (residence time 1.5 minutes).

Mixing energy was added to the vessel with a vertical shaft 933 impeller 934a, 934b. Two alternate impellers were used in the experiments. The two impellers are illustrated in FIGS. 9C and 9D. The first impeller 934a was a 60° pitched blade turbine (diameter 63 mm, 70 mm width of blades, 20 mm length of the blades) and the second 934b was a 45° pitched blade turbine (diameter 69 mm, 13 mm width of blades, 20 mm length of the blades). The impeller speed was controlled between 100 and 3,000 rpm.

Removable divider 904 was positioned above the baffles 926 at 140 mm height above the floor of the tank, to separate the upper and the lower liquid volumes. A transport passageway 910 included a 70 mm hole in the center of divider 904. Radial baffles were placed above the cover. A 40 mm diameter disk baffle 930 was fixed on the shaft 933.

In order to validate the mathematical model, a series of experiments were performed with different setups. The setup parameters were impeller type, quantity of baffles in the tank and the presence or absence of a surfactant (see Table 1). For each setup the height of the upper part (h2) and the flow rate (Q′) were varied. For each combination of parameters the impeller speed n at the minimum aeration limit was recorded for the systems with and without divider 904 and baffles 928.

TABLE 1
Summary of different experimental conditions

| | Setup 1 | Setup 2 | Setup 3 | Setup 4 | Setup 5 |
|---|---|---|---|---|---|
| Impeller | A | A | A | B | B |
| Number of baffles | 6 | 6 | 2 | 6 | 6 |
| Surfactant added | Yes | No | No | No | Yes |
| Height of the upper zone, | 9-40 | | | | |
| h mm | | | | | |
| Flow rate, L/min | 0-1.3 | 0-1.3 | 0 | 0-1.3 | 0-1.3 |

All experiments were performed with purified water (HPLC grade). Surface tension was modified by adding Polysorbate 20 (Tween®-20).

10) Example—Results—Images

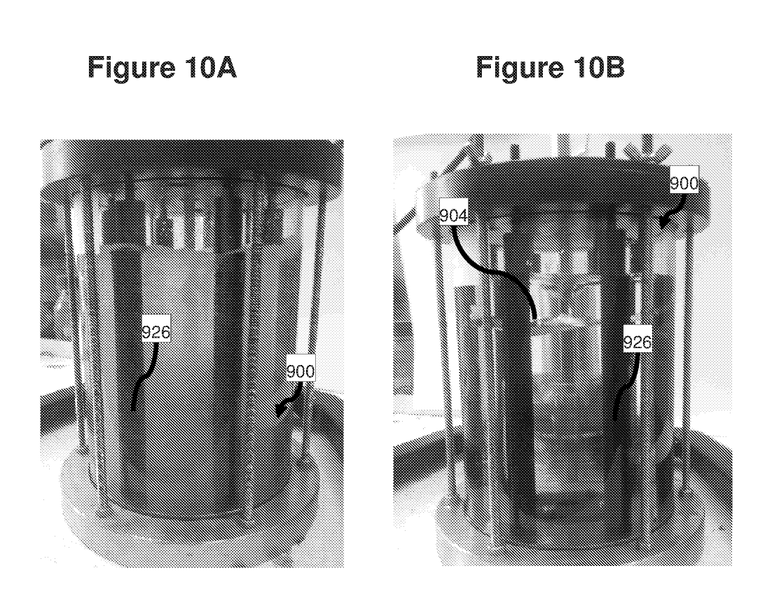

FIGS. 10A and 10B illustrate air ingestion onset for experiments with the mixed tank illustrated in FIGS. 9A-9E. FIG. 10A illustrates the experimental results without divider 904 and baffles 928. FIG. 10B illustrates the experimental results with divider 904 and baffles 928 in accordance with some embodiments of the present invention. In FIG. 10A it is seen that the mixing tank without divider 904 and baffles 928 reaches MAL at mixing speeds equal to or greater than 350 rpm. In FIG. 10B it is seen that the mixing tank with divider 904 and baffles 928 in accordance with some embodiments of the current invention does not reach MAL at speed below 700 rpm. Process conditions are described in Table 1 Setup 2.

Our experiments have shown, that dividing the tank in accordance with some embodiments of the current invention is able to suppress air intake for impeller rotation at for example twice the speed at which air is ingested without the device. For example, FIG. 10A illustrates that without divider 904 and baffles 928 the experimental system shows intensive air uptake at 350 rpm. FIG. 10B illustrates that with divider 904 and baffles 928 the experimental system shows almost no discernible air capture at 700 rpm.

11) Example—Results Graphs

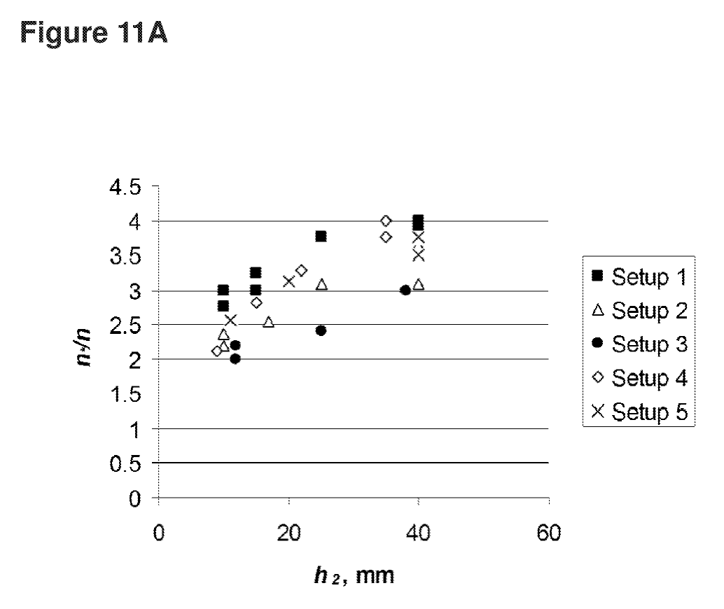

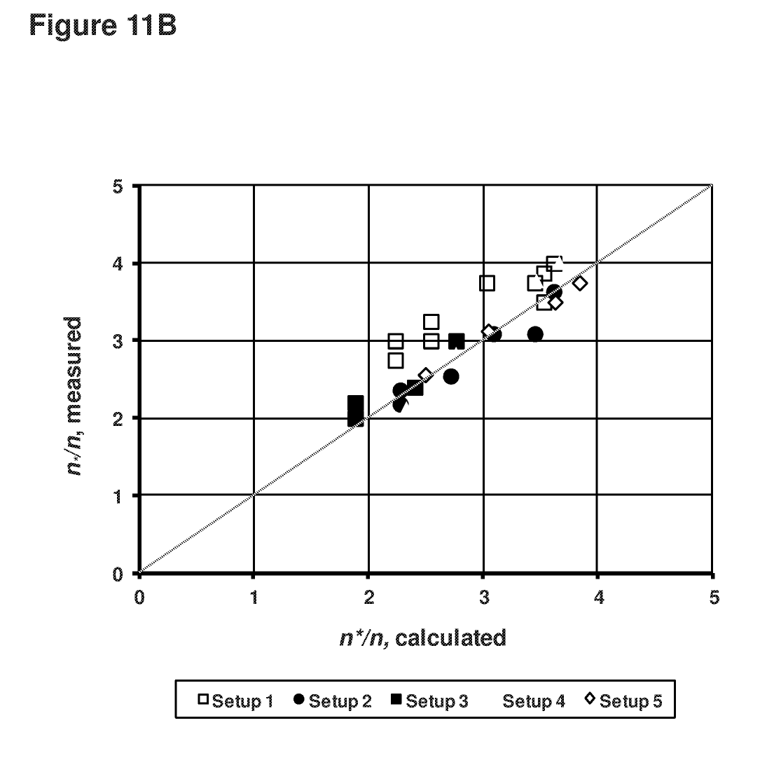

Experimental results are presented in FIGS. 11A and 11B.

FIG. 11A is a graph of the ratio of impeller speed at the minimum aeration limit MAL for a tank without a divider and a tank with a divider according to some embodiments of the present invention. The depth of the upper zone was chosen as an independent variable.

The power input to a stirred tank can be estimated (Hamby et al., 1997) as P=Kₚρn³dᵢₘₚₑₗₗₑᵣ⁵; accordingly the ratio of the energies ε_{*}/ε can be expressed as

$$\frac{{ɛ}_{*}}{ɛ} = {( \frac{{n}_{*}}{n} )}^{3} \qquad Eq .5$$

Note, that doubling the impeller velocity ratio (n_{*}/n=2) corresponds to an eight times increase in power input (ε_{*}/ε=8), i.e. much more intensive mixing.

FIG. 11B is a graph illustrating correlation between a calculated ratio of energy between the quiescent and actively stirred zones and measured ratios of impeller speed at the minimum aeration limit MAL for a tank without a divider and a tank with a divider according to some embodiments of the present invention.

Note that the value characteristic length was kept λ₁=0.4·(0.3R), i.e. ξ=0.12. The experimental results fall very close to the line y=x, supporting the assumption that the turbulent diffusion through the opening has the same structure as in the bulk.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of reducing ingestion across an interface of a mixing tank comprising:
mixing a first zone including at least 75% of the mixing tank to achieve a first bulk energy dissipation rate in said first zone;
preserving in a second zone near the interface a second bulk energy dissipation rate, said second energy dissipation rate being less than half of said first bulk energy dissipation rate; and
transporting material between the first zone and the second zone.

2. The method of claim 1, wherein said preserving includes obstructing a path of flow directed from said first zone toward said second zone.

3. The method of claim 1, wherein said preserving includes placing a divider in an upflow region of an unobstructed flow.

4. The method of claim 1, wherein said preserving includes increasing a depth of said second zone when the second bulk energy dissipation rate surpasses a minimum air entry level.

5. The method of claim 4 wherein said increasing a depth of said second zone includes increasing a water level in the tank.

6. The method of claim 1, wherein said preserving includes decreasing said transporting when the second bulk energy dissipation rate surpasses a minimum air entry level.

7. The method of claim 6, wherein said decreasing transporting includes decreasing a net inter-zone flow rate from said first zone to said second zone.

8. The method of claim 7, wherein said decreasing transport includes changing a rate of external circulation.

9. The method of claim 7, wherein said decreasing transport includes changing a balance of inflow rate and outflow rate between said first zone and said second zone.

10. The method of claim 1, further comprising:
interrupting a central vortex.

11. The method of claim 10, wherein said interrupting includes preventing a central vortex from crossing between said first zone and said second zone.

12. The method of claim 10, wherein said interrupting includes placing a central baffle in a location of an uninterrupted central vortex.

13. The method of claim 1, further including:
detecting a high level of said ingestion and adjusting an inter-zone flow rate to reduce said ingestion.

14. A mixing tank for reducing ingestion across an interface comprising:
a first zone including at least 75% of the total volume of the tank;
a second zone including the interface;
a source of mixing energy configured to provide a first rate of bulk energy dissipation in said first zone;
a divider located between said first zone and said second zone interfering with transfer of said mixing energy from said first zone to said second zone to preserve in said second zone a bulk energy dissipation rate less than half said first bulk energy dissipation rate; and
a mass transport passageway between said first zone and said second zone.

15. The mixing tank of claim 14 wherein said divider obstructs a flow path from said first zone to said second zone in an unobstructed mean flow.

16. The mixing tank of claim 14, wherein said mass transport passageway includes an opening in said divider.

17. The mixing tank of claim 14, further including:
a second baffle interrupting a central vortex.

18. The mixing tank of claim 17, wherein said second baffle prevents said central vortex from penetrating from said second zone to said first zone.

19. The mixing tank of claim 18, wherein said second baffle is placed in a location of said central vortex in the uninterrupted flow.

20. The mixing tank of claim 14 wherein said transport passageway has a cross sectional area of smaller than eleven times the depth of said second zone multiplied by the square root of the area of said interface divided by the sum of 1 and the square of the ratio of the average rotation velocity in the first zone to the average pulsation velocity in the bulk of the first zone.

21. The mixing tank of claim 14, wherein said divider can be moved to change a volume of said first zone.

22. The mixing tank of claim 14, wherein said divider includes a peripheral baffle obstructing flow between said first zone and said second zone along a wall of the tank and wherein said divider includes said passageway in a central portion thereof.

23. The mixing tank of claim 22, wherein a width of said peripheral baffle is at least a third the hydraulic radius of the mixing tank.

24. The mixing tank of claim 22, wherein said peripheral baffle is in the form of an annulus.

25. The mixing tank of claim 14, further comprising:
a sensor for a level of said ingestion and
a controller for adjusting an inter-zone flow rate in response to said sensing.

26. The mixing tank of claim 14, wherein an outlet can be adjusted to change a volume of said second zone.

27. A method for producing a mixing tank with reduced ingestion across an interface comprising:
dividing a first zone including at least 75% of the total volume of the tank from a second zone including the interface;
installing a source of mixing energy source in said first zone providing turbulent flow;
interfering with energy transfer from said first zone to said second zone; and
providing a passageway for material transport between said first zone and said second zone.

28. The method of claim 27, wherein said interfering includes obstructing a flowpath in uninterfered mean flow from said first zone towards said interface.

29. The method of claim 28, wherein said flowpath is an upflow path.

30. The method of claim 27, wherein said passageway is configured to preserve a bulk energy dissipation rate in said second zone that is less than ½ a bulk energy dissipation rate in said first zone.

31. The method of claim 27, wherein said energy source is an impeller.

32. The method of claim 31, further comprising:
providing a baffle for inhibiting tangential flow in said first zone.

33. The method of claim 31, further comprising:
providing a baffle for inhibiting tangential flow in said second zone.

34. The method of claim 27, further comprising:
configuring said tank for changing a volume of said first zone.

35. The method of claim 34, wherein the configuring includes configuring said divider to move.

36. The method of claim 27, further comprising:
configuring said tank for changing a volume of said second zone.

37. The method of claim 36, wherein the configuring includes configuring a fluid outlet to move.

38. A method of retrofitting a mixing tank to reduce ingestion across an interface comprising:
dividing a first zone including at least 75% of the total volume of the tank from a second zone including the interface;
interfering with energy transfer from said first zone to said second zone; and
providing a passageway for material transport between said first zone and said second zone.

39. The method of claim 38, wherein said interfering includes obstructing a flowpath in uninterfered mean flow from said first zone towards said interface.

40. The method of claim 39, wherein said flowpath is an upflow path.

41. The method of claim 38, wherein said passageway is configured to preserve a bulk energy dissipation rate in said second zone that is less than ½ a bulk energy dissipation rate in said first zone.

42. The method of claim 38, further comprising:
providing a baffle for inhibiting tangential flow in said first zone.

43. The method of claim 38, further comprising:
providing a baffle for inhibiting tangential flow in said second zone.

44. The method of claim 38, further comprising:
configuring said tank for changing a volume of said first zone.

45. The method of claim 44, wherein the configuring includes configuring said divider to move.

46. The method of claim 38, further comprising:
configuring said tank for changing a volume of said second zone.

47. The method of claim 46, wherein the configuring includes configuring a fluid outlet to move.
